(19) United States
(12) Patent Application Publication
(10) Pub. No.: US 2010/0015927 A1
(43) Pub. Date: Jan. 21, 2010

(54) RADIO COMMUNICATION DEVICE AND RADIO COMMUNICATION METHOD

(75) Inventors: Yasuaki Yuda, Osaka (JP); Masayuki Hoshino, Osaka (JP); Katsuhiko Hiramatsu, Osaka (JP); Tomohiro Imai, Osaka (JP); Ryohei Kimura, Osaka (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/446,911

(22) PCT Filed: Oct. 23, 2007
(86) PCT No.: PCT/JP2007/070614

§ 371 Date: May 21, 2009

(30) Foreign Application Priority Data
Oct. 24, 2006 (JP) 2006-288950
May 1, 2007 (JP) 2007-120847

(51) Int. Cl. H04B 7/00; H04L 27/28

(52) U.S. Cl. 455/69; 375/260

(57) ABSTRACT

Disclosed are a radio communication device and a radio communication method capable of suppressing fluctuations of interference given to an adjacent cell while maintaining a beam gain to a UE of a local cell even when a transmission beam is switched. According to the device and the method, ST201 to ST205 measure CQI using one transmission beam selected from a plurality of transmission beams and a random pattern selected from a plurality of random patterns, for all the transmission beams and for all the combinations of the random patterns. ST206 selects the transmission beam and the random pattern having the maximum CQI among the measured CQI. ST207 transmits the transmission beam and the random pattern selected in ST206 as feedback information to a transmission device (100).

### TECHNICAL FIELD

The present invention relates to a wireless communication apparatus and wireless communication method for forming a plurality of transmission beams.

### BACKGROUND ART

Recently, MIMO (Multi Input Multi Output) is focused upon in a wireless communication technique as a technique for realizing high speed communication of large capacity. MIMO is the technique for transmitting and receiving data using a plurality of antennas. By transmitting different data from a plurality of transmitting antennas, it is possible to improve the transmission capacity without expanding time and frequency resources.

In this MIMO, there is a beam transmitting method of forming a beam by transmitting weighted data from each antenna when transmission is performed from a plurality of antennas. Beam transmission provides an advantage of increasing received power of terminals by beam gains.

Further, spatial multiplexing using a plurality of beams is possible, and, in this case, it is possible to improve transmission capacity for spatial multiplexing using a plurality antennas by performing beam transmission suitable to the channel condition. In this case, it is necessary to report information of beams suitable to the channel condition on the receiving side to the transmitting side.

Further, currently, 3GPP (3rd Generation Partnership Project), which is an international standardization group for mobile telephones, campaigns for standardization of the LTE (Long Term Evolution) system as a system for realizing high speed communication of large capacity of the current third generation mobile telephones. In this LTE, to implement requirements of high speed transmission of large capacity, MIMO is regarded as an essential technique. Further, in this LTE, the transmission beam technique is discussed for a pre-coding technique.

As a general beam transmitting method, a beam transmitting method of closed loop control of controlling a transmission beam according to the channel condition of a terminal is known. For example, according to this method, a terminal selects a transmission beam according the channel condition such that high quality is achieved and feeds back this transmission beam information to a base station, and the base station performs beam transmission based on beam information fed back.

In such a beam transmitting method of closed loop control, when a terminal communicating with the base station switches, the transmission beam switches in association with this switching, and, therefore, the amount of interference given to adjacent cells fluctuates. Accordingly, when beam switching takes place between the time of quality measurement and the time of data transmission, the quality upon data transmission differs from the quality upon quality measurement differs, and, therefore, link adaptation does not function in a terminal in the adjacent cell.

A case where the amount of interference given to the adjacent cell fluctuates due to switching of transmission beams will be explained specifically below. FIG. 1 shows how beams are switched. In this figure, base station 1 (BS 1) performs transmission for terminal 1 (UE 1) and terminal 2 (UE 2) using different beams, and terminal 3 (UE 3) is connected with base station 2 (BS 2) in an adjacent cell. First, BS 1 performs transmission for UE 1 using beam 1 and, then, performs transmission for UE 2 using beam 2.

FIG. 2 is an example showing the receiving state in UE 3 before and after beam switching shown in FIG. 1. Interference by beam 1 is observed as interference from BS 1, which is adjacent cell interference, before the beams switch (t0 to t3), and quality measurement is performed in UE 3. Interference by beam 2 is observed after beams switch (t3 to t6), and data transmission is performed in UE 3 using the quality measurement result at t3 to t6. If the amount of interference changes between the time of quality measurement and the time of beam transmission, the SIR (Signal to Interference Ratio) in UE 3 changes and quality fluctuates. As a result, link adaptation controlled based on this quality stops functioning.

For example, there is a method of randomizing beams disclosed in Non-Patent Document 1 as a technique of suppressing the fluctuation of given interference by such beam transmission. This technique disclosed in Non-Patent Document 1 is a technique of switching a beam per subcarrier at random when a transmission signal uses a multicarrier transmission scheme such as an OFDM signal. By this means, it is possible to minimize the average amount of interference in a transmission band in interference given to the adjacent cell and suppress the fluctuation of the average amount of interference even though beams switch.

The technique disclosed in Non-Patent Document 1 will be explained specifically below. FIG. 3 shows how beam transmission is performed using a plurality of beams. FIG. 4 shows the receiving states in UE 1 connected with BS 1 and UE 3 which is an adjacent cell terminal. Here, frequency response is shown as the receiving state in each UE. According to the receiving state in UE 1 shown in FIG. 4A, quality is optimal in case where beam 1 is used. Further, according to the receiving state in UE 3 shown in FIG. 4B, the amount of interference received from BS 1 varies depending on beams.

Next, FIG. 5 shows the receiving states in UE 1 and UE 3 in case where transmission is performed in BS 1 by switching between beam 1 to beam 4 per subcarrier of a transmission signal. According to the receiving state in UE 3 shown in FIG. 5B, the amount of interference is randomized by switching a beam for each subcarrier at random, so that the average level decreases in the band. Further, even when transmission is performed using a beam pattern different from the beam pattern shown in FIG. 5A, the amount of interference is randomized likewise. In this way, by switching transmission beams at random in the frequency domain, it is possible to minimize the fluctuation of interference given to adjacent cells.

Non-Patent Document 1: “Description of Single and Multi Codeword Schemes with Precoding,” 3GPP TSG-RAN WG1 #44 R1-060457, Feb. 13-17, 2006, Denver, USA.

### DISCLOSURE OF INVENTION

### Problems to be Solved by the Invention

However, as shown by the receiving state in UE 1 of FIG. 5A, the beam gain resulting from a transmission beam decreases eventually. In this way, while the beam randomizing method disclosed in above-described Non-Patent Document 1 makes it possible to suppress the fluctuation of interference given to adjacent cells, there is a problem that beam gain decreases in a target UE (UE in a relevant cell) for which beam gain must be improved.

It is therefore an object of the present invention to provide a wireless communication apparatus and wireless communication method for suppressing the fluctuation of interference given to adjacent cells while maintaining beam gain for a UE in a relevant cell even when transmission beams switch.

### Means for Solving the Problem

The wireless communication apparatus according to the present invention employs a configuration including: a controlling section that acquires feedback is information transmitted from a communicating party and that selects a randomization pattern in which an arrangement of a plurality of transmission beams is randomized, according to a channel condition shown by the acquired feedback information; and a beam forming section that forms transmission beams based on the selected randomization pattern.

The wireless communication method according to the present invention includes: acquiring feedback information transmitted from a communicating party and selecting a randomization pattern in which an arrangement of a plurality of transmission beams is randomized, according to a channel condition shown by the acquired feedback information; and forming transmission beams based on the selected randomization pattern.

### ADVANTAGEOUS EFFECT OF THE INVENTION

The present invention makes it possible to suppress the fluctuation of interference given to adjacent cells while maintaining beam gain for a UE in a relevant cell even when transmission beams switch.

### BRIEF DESCRIPTION OF DRAWINGS

FIG. 1 shows how beam switching is performed;

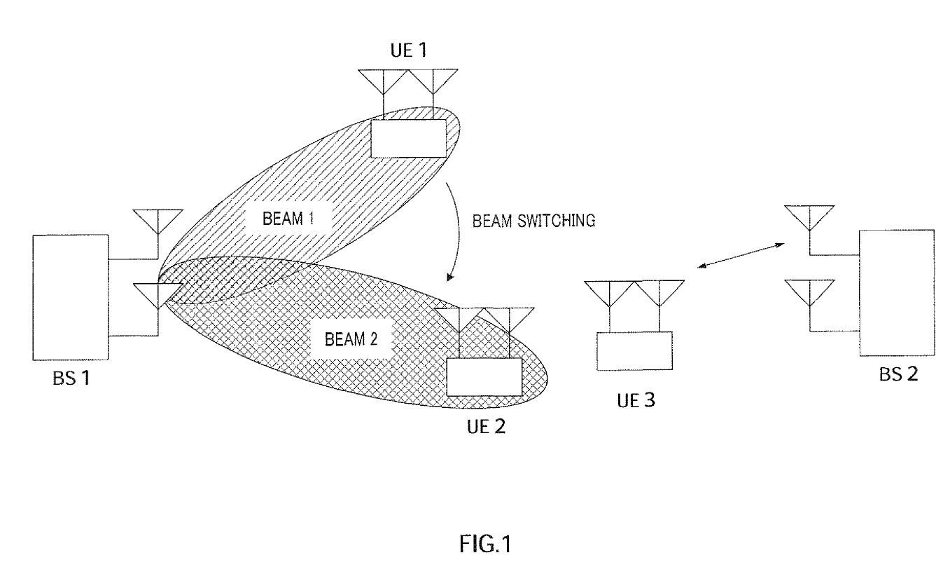

FIG. 2 shows the receiving state in UE 3 before and after beam switching shown in FIG. 1;

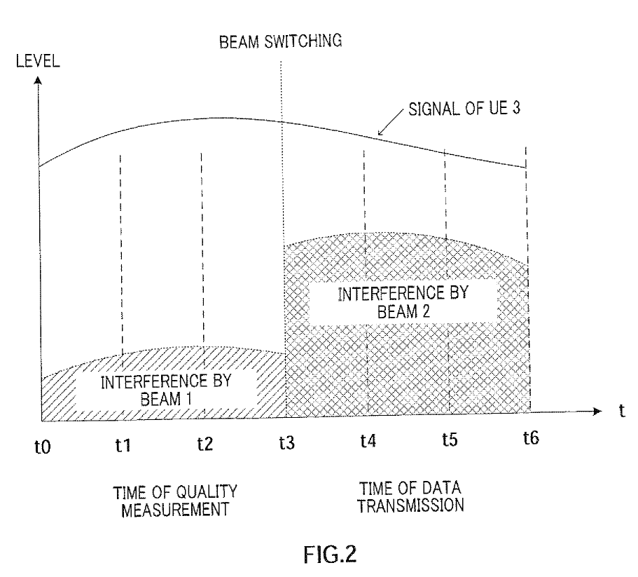

FIG. 3 shows how beam transmission is performed using a plurality of beams;

FIG. 4 shows the receiving states in UE 1 connected with BS 1 and adjacent cell terminal UE 3;

FIG. 5 shows the receiving states in UE 1 and UE 3 in case where transmission is performed in BS 1 by switching between beam 1 to beam 4 per subcarrier of a transmission signal;

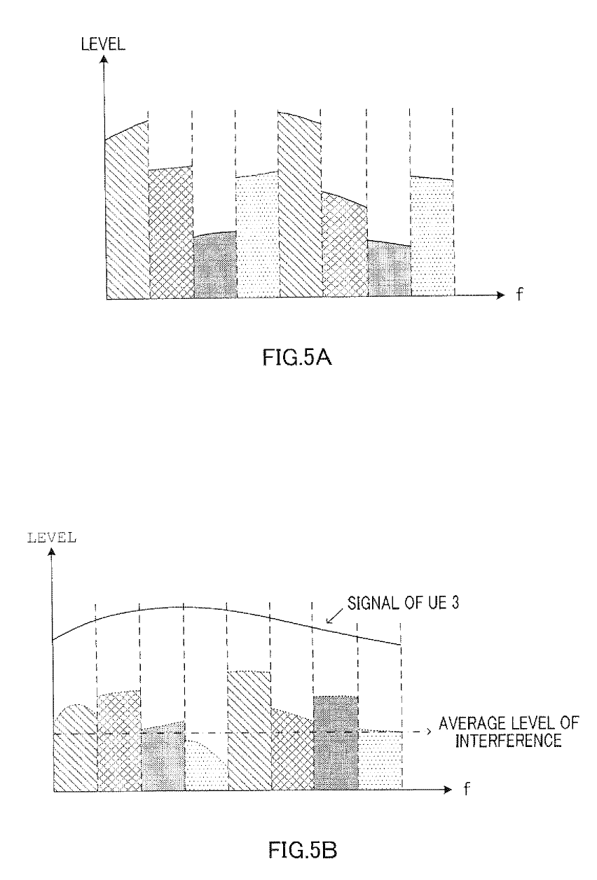

FIG. 6 is a block diagram showing a configuration of a transmitting apparatus according to Embodiments 1 to 3 of the present invention;

FIG. 7 is a block diagram showing a configuration of a receiving apparatus according to Embodiment 1 of the present invention;

FIG. 8 is a flowchart showing selection processing in a transmission beam and randomization pattern selecting section of the receiving apparatus shown in FIG. 7;

FIG. 9 shows a randomization pattern according to Embodiment 1 of the present invention;

FIG. 10 shows a CQI measurement result in case where each randomization pattern in UE 1 is applied;

FIG. 11 shows the receiving state in UE 3 in case where beam transmission is performed by applying each pattern;

FIG. 12 is a block diagram showing a configuration of the receiving apparatus according to Embodiment 2 of the present invention;

FIG. 13 is a flowchart showing the selection processing in the transmission beam and randomization pattern selecting section of the receiving apparatus shown in FIG. 12;

FIG. 14 shows randomization patterns according to Embodiment 2 of the present invention;

FIG. 15 is a block diagram showing the configuration of the receiving apparatus according to Embodiment 3 of the present invention;

FIG. 16 shows the receiving state in a target user in case where frequency selectivity which moderately changes with respect to the measured band is generated;

FIG. 17 is a block diagram showing a configuration of the transmitting apparatus according to Embodiment 4 of the present invention;

FIG. 18 is a block diagram showing a configuration of the transmitting apparatus according to Embodiment 4 of the present invention;

FIG. 19 shows the receiving state in a target user in case where short delay CDD and long delay CDD are used at the same time;

FIG. 20 shows a state where the CQI is measured using each pattern shown in table 1; and

FIG. 21 shows the receiving state in an adjacent cell user in case where transmission is performed using each pattern shown in table 1.

### BEST MODE FOR CARRYING OUT THE INVENTION

Embodiments of the present invention will be explained in detail with reference to the accompanying drawings. However, in the embodiments, configurations having the same functions will be assigned the same reference numerals and repetition of description will be omitted.

### Embodiment 1

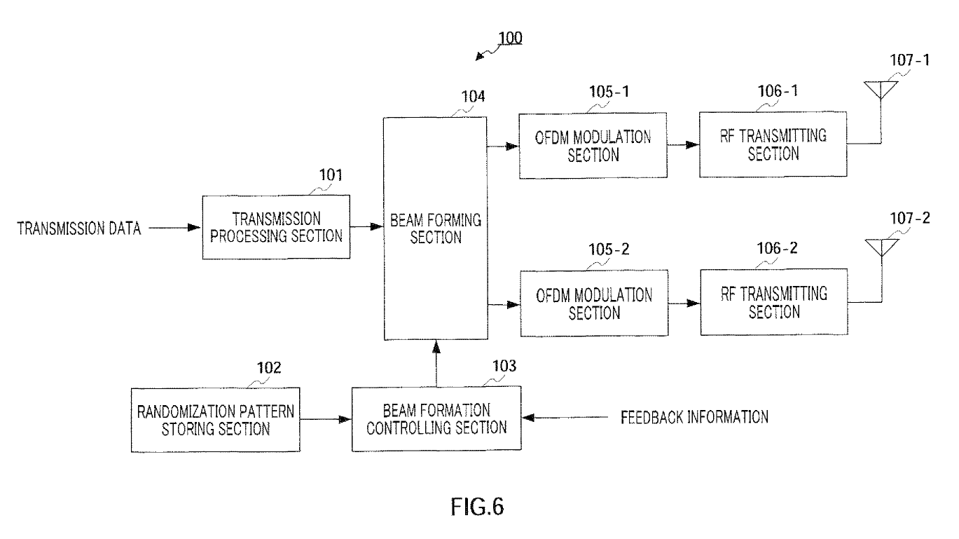

FIG. 6 is a block diagram showing a configuration of transmitting apparatus 100 according to Embodiment 1 of the present invention. Transmitting apparatus 100 has two transmitting antennas and is mounted in a wireless communication apparatus such as a base station apparatus.

In transmitting apparatus 100, transmission processing section 101 receives as input transmission data. Transmission processing section 101 carries out transmission processing such as error correction coding and modulation processing for transmission data received as input, and outputs a signal subjected to the transmission processing to beam forming section 104.

Randomization pattern storing section 102 stores randomization patterns which associate subcarriers with beams, and outputs the stored randomization patterns to beam forming section 103.

Beam formation controlling section 103 acquires feedback information transmitted from receiving apparatus 150 (described later) and reads a randomization pattern from randomization pattern storing section 102 based on the acquired feedback information. Beam formation controlling section 103 determines a weight per subcarrier according to the read randomization pattern and outputs the determined weight to beam forming section 104.

Beam forming section 104 multiplies the transmission signal outputted from transmission processing section 101, with the weight outputted from beam formation controlling section 103 and weights the transmission signal. The weighted transmission signal is outputted to OFDM modulation sections 105-1 and 105-2.

OFDM modulation sections 105-1 and 105-2 carry out OFDM modulation such as IFFT (Inverse Fast Fourier Transform) processing and GI (Guard Interval) insertion for the transmission signal outputted from beam forming section 104, and outputs the transmission signals subjected to OFDM modulation to REF transmitting sections 106-1 and 106-2.

RF transmitting sections 106-1 and 106-2 carry out radio transmission processing such as D/A conversion and up-conversion for the transmission signals outputted from OFDM modulation sections 105-1 and 105-2, and transmit by radio the signals subjected to radio transmission processing through applicable antennas 107-1 and 107-2.

Further, although transmitting apparatus 100 requires a plurality of transmission data and transmission processing sections in case where beam multiplexing transmission is performed using a plurality of beams, the basic processing is the same. Further, although the numbers of OFDM modulation sections, RF transmitting sections and antennas increase in case where there are three or more transmitting antennas, the basic processing is the same.

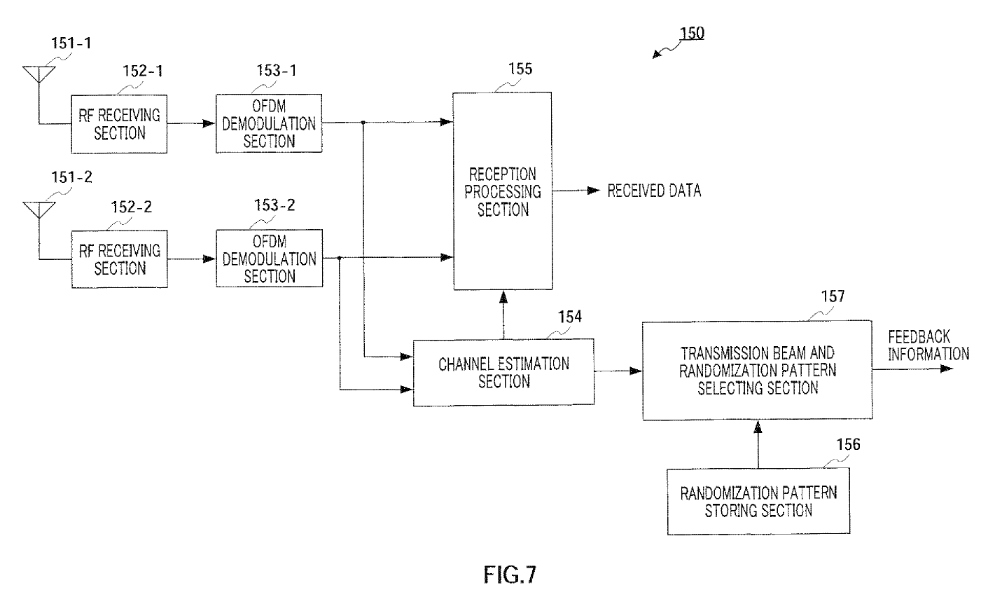

FIG. 7 is a block diagram showing a configuration of receiving apparatus 150 according to Embodiment 1 of the present invention. Receiving apparatus 150 has two receiving antennas, and is mounted in a wireless communication apparatus such as a mobile terminal.

In receiving apparatus 150, RF receiving sections 152-1 and 152-2 receive signals transmitted from transmitting apparatus 100 shown in FIG. 6 through antennas 151-1 and 151-2. RF receiving sections 152-1 and 152-2 carry out radio reception processing such as down-conversion and A/D conversion for the received signals and output the signals subjected to radio reception processing to applicable OFDM demodulation sections 153-1 and 153-2.

OFDM demodulation sections 153-1 and 153-2 carry out OFDM demodulation such as GI removal and FFT (Fast Fourier Transform) processing for the signals outputted from RF receiving sections 152-1 and 152-2, and output the signals subjected to OFDM demodulation to channel estimation section 154 and reception processing section 155.

Channel estimation section 154 estimates channel conditions between the transmitting antennas (antennas 107-1 and 107-2) and receiving antennas (antennas 151-1 and 151-2) based on the signals outputted from OFDM demodulation sections 153-1 and 153-2, and outputs this estimation result, that is, a channel estimation value, to reception processing section 155 and transmission beam and randomization pattern selecting section 157. Further, channel estimation is performed per subcarrier here.

Reception processing section 155 carries out demodulation processing and decoding processing for the signals outputted from OFDM demodulation sections 153-1 and 153-2 using the channel estimation value outputted from channel estimation section 154, and outputs received data.

Randomization pattern storing section 156 stores the same patterns as the patterns included in randomization pattern storing pattern 102 of transmitting apparatus 100 shown in FIG. 6, and outputs the stored randomization patterns to transmission beam and randomization pattern selecting section 157.

Transmission beam and randomization pattern selecting section 157 measures the CQI per randomization pattern stored in randomization pattern storing section 156 using the channel estimation value outputted from channel estimation section 154, and selects the randomization pattern in which the CQI is maximum in measured CQI's and a target transmission beam in this randomization pattern. The selected randomization pattern and target transmission beam are transmitted as feedback information to beam formation controlling section 103 of transmitting apparatus 100 shown in FIG. 6.

Further, when transmitting apparatus 100 performs beam multiplexing transmission using a plurality of beams, in receiving apparatus 150, reception processing section 155 performs MIMO reception processing. MIMO reception processing includes methods of, for example, spatial filtering, SIC (Successive Interference Canceller) and MLD (Maximum Likelihood Detection). Further, although the numbers of antennas, RF receiving sections and OFDM demodulation sections increase in case where the number of receiving antennas is three or more, the basic processing is the same.

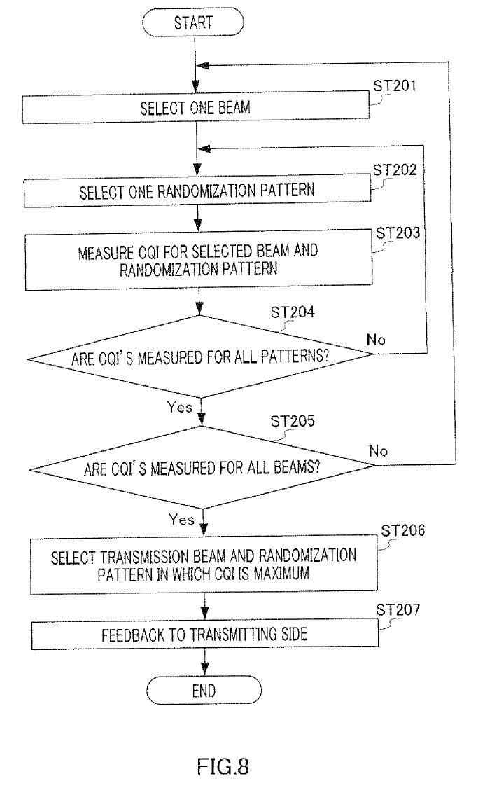

Next, selection processing in transmission beam and randomization pattern selecting section 157 of receiving apparatus 150 shown in FIG. 7 will be explained using FIG. 8. In step (hereinafter, abbreviated as “ST”) 201, one transmission beam is selected from a plurality of transmission beams and, in ST202, one pattern is selected from randomization pattern storing section 156.

In ST203, using the transmission beam selected in ST201 as a target beam, the CQI is measured in case where the randomization pattern selected in ST202 is used. The measured CQI is stored in association with the selected transmission beam and randomization pattern.

In ST204, whether or not CQI's of all randomization patterns are measured is decided for the transmission beam selected in ST201. When it is decided that CQI's of all randomization patterns have been measured (Yes), the flow proceeds to ST205 and, when it is decided that CQI's of all randomization patterns have not been measured (No), the flow returns to ST202.

In ST205, whether or not all of a plurality of transmission beams have been measured is decided, and, when it is decided that all beams have been measured (Yes), the flow proceeds to ST206, and, when it is decided that all beams have not been measured (No), the flow returns to ST201.

In ST206, the transmission beam and randomization pattern in which the CQI is maximum in CQI's measured in ST203 are selected, and, in ST207, the transmission beam and randomization pattern selected in ST206 are transmitted to transmitting apparatus 100 as feedback information.

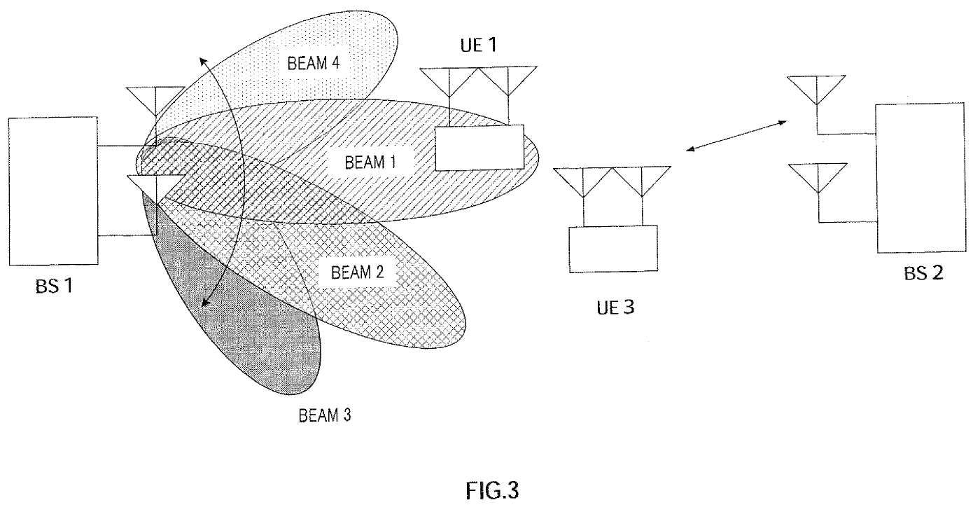

Next, the randomization pattern selected by transmission beam and randomization pattern selecting section 157 will be explained. This explanation will be made using the relationship shown in FIG. 3, that is, the relationship between UE 1 connected with BS 1 and UE 3 which is an adjacent cell terminal. Further, BS 1 corresponds to transmitting apparatus 100 and UE 1 corresponds to receiving apparatus 150.

Transmission beam and randomization pattern selecting section 157 selects a randomization pattern according to the channel condition of UE 1. Here, for example, frequency response shows the channel condition. Because frequency response is determined by a delay wave component in a received signal, between UE 1 and UE 3, the delay wave component varies and different frequency response characteristics are shown. Consequently, by selecting the randomization pattern according to frequency response of UE 1, transmission beam and randomization pattern selecting section 157 is able to provide a randomizing effect of suppressing the fluctuation of interference with respect to UE 3 while securing beam gain for UE 1.

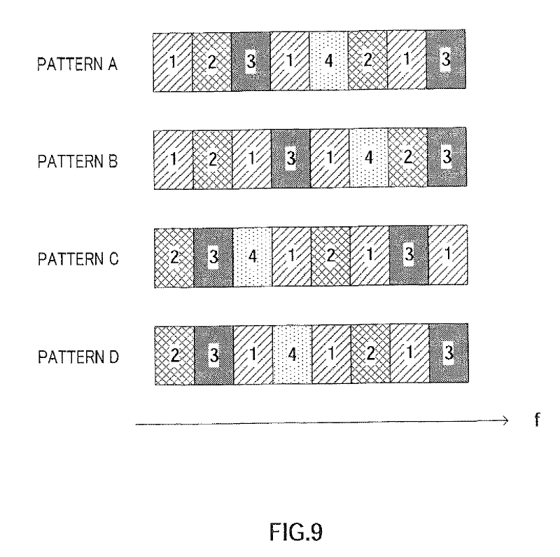

To realize such a selecting method, for example, patterns as shown in FIG. 9 are prepared in randomization pattern storing sections 102 and 156 as randomization patterns. With this example, the number of randomization patterns is four from pattern A to pattern D. Each pattern is randomized using four beams (in FIG. 9, 1 to 4 refer to beams 1 to 4).

Here, beam 1 is the target beam, and beam 2 to beam 4 are beams to be randomized. Further, the number of subcarriers for which beams switch is eight and the target beam uses three of the eight subcarriers. Each pattern matches varying frequency response.

Pattern A arranges the target beam across the entire band and is able to secure gain in case where frequency response characteristics are flat in the entire band. Further, pattern B arranges the target beams in lower frequencies and pattern C arranges the target beams in higher frequencies. Furthermore, pattern D arranges the target beams in the center of the band, and it is possible to secure gain by selecting one of patterns A to D according to frequency response characteristics.

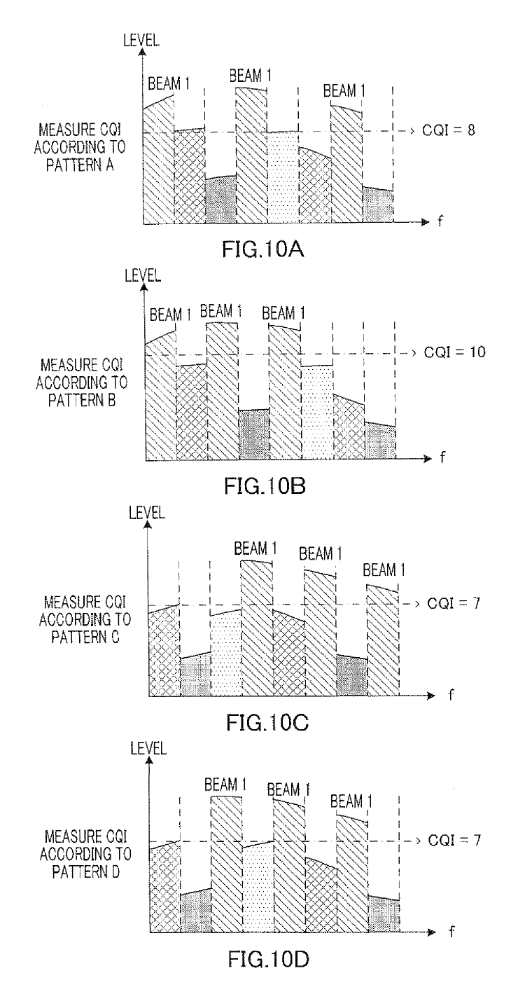

FIG. 10 shows a CQI measurement result in case where each randomization pattern is applied in UE 1. In this figure, the CQI is maximum when pattern B is applied. Consequently, beam 1 is selected as the target beam and pattern B is selected as the randomization pattern.

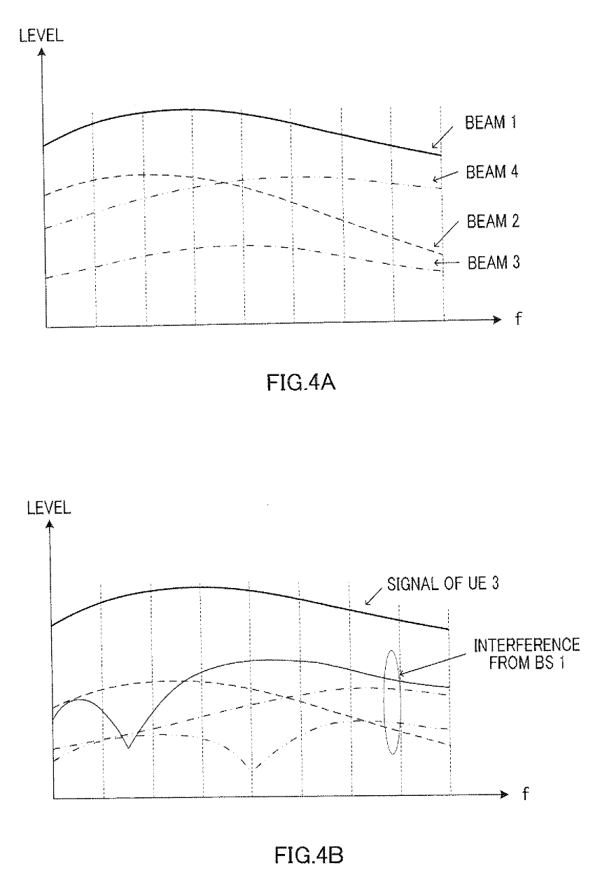

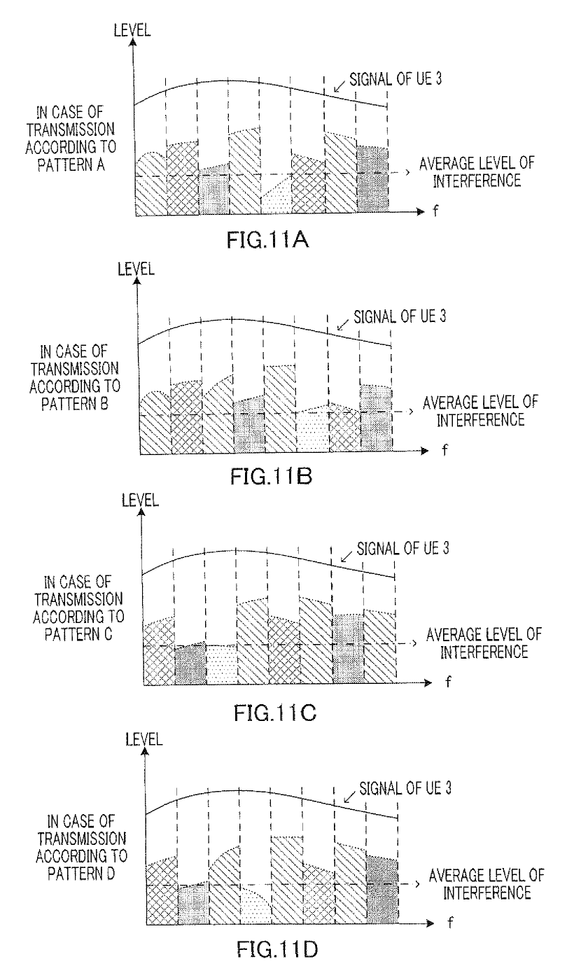

On the other hand, FIG. 11 shows the receiving state in UE 3 in case where beam transmission is performed by applying each pattern. Here, the receiving states in UE 1 and UE 3 in case where transmission is performed using each beam from beam 1 to beam 4 are the same as the receiving states shown in FIG. 4. As is clear from FIG. 11, the average level of interference can be suppressed small thanks to the randomizing effect even when beam transmission is performed by BS 1 using any pattern, and the average levels of interference are suppressed small between patterns. Further, even when pattern B is selected according to the channel condition of UE 1 as shown in FIG. 10, the randomizing effect works on UE 3, and, consequently, the average level of interference does not fluctuate substantially compared to other patterns.

According to Embodiment 1, by selecting in the receiving apparatus the randomization pattern and transmission beam in which the CQI is maximum in randomization patterns which associate subcarriers with transmission beams, it is possible to suppress the fluctuation of interference given to an adjacent cell while maintaining beam gain for a UE in a relevant cell even when transmission beams switch.

Further, although a case has been explained with the present embodiment where the receiving apparatus determines the randomization pattern, the present invention is not limited to this and, by feeding back the channel condition itself, the transmitting apparatus may determine the randomization pattern. According to this method, the receiving apparatus feeds back the channel condition, and the transmitting apparatus selects a randomization pattern suitable to the channel condition fed back and performs transmission beam formation using this randomization pattern. At this point, the randomization pattern selected by the transmitting apparatus is reported to the receiving apparatus using, for example, control information. Although this method increases the amount of feedback information due to the feedback of the channel condition itself, it is possible to select a randomization pattern that is highly adaptable to the receiving state.

Further, although a case has been explained with the present embodiment where randomization patterns are provided in a table and are shared both in the transmitting apparatus and receiving apparatus, the present invention is not limited to this and the randomization patterns may be changed dynamically. According to this method, a number of randomization patterns are prepared in advance. A plurality of patterns are selected from these patterns to make one group. By reporting the patterns in this group in advance, the patterns are shared both in the transmitting apparatus and receiving apparatus. To determine the group, there is a method of selecting patterns according to the receiving state in a UE and determining the group or a method of combining random patterns in a BS and determining the group. Then, the UE selects a randomization pattern from this group and feeds it back to the BS. At this time, an indicator is fed back as described above. According to this method, although the amount of feedback information increases when the UE determines and reports a group, it is possible to select a randomization pattern that is highly adaptable to the receiving state.

Further, although randomization in the frequency domain has been explained with the present embodiment as the transmission beam randomizing method, the present invention is not limited to this and it may be possible to select one of domains according to the channel condition from different domains and use the randomizing method in the selected domain.

For example, by setting randomization in the frequency domain and randomization in the time domain, one of the frequency domain and time domain is selected according to the channel condition. To be more specific, when time fluctuation is significant in the channel, even if a plurality of time symbols use the same beam, gain becomes smaller due to this time fluctuation. Therefore, when time fluctuation is significant in this way, by selecting randomization in the time domain, time symbols using the target beam come to use the target beam for the entire frequency band, so that it is possible to improve beam gain. In this case, it is possible to suppress the average amount of interference in a plurality of symbols by randomization in the time domain.

Further, different domains may be selected according to the channel condition as a randomizing method of combining different domains. For example, randomization patterns (described above) in which the frequency domain and time domain are combined are prepared and the randomization pattern is selected according to the channel condition. According to the selecting method, when time fluctuation is significant, randomization in the time domain is preferentially performed as described above.

Further, with the present embodiment, randomization patterns associated with arrangement of a pilot signal may be used as randomization patterns. When frequency response or time response fluctuates significantly in channel characteristics, channel estimation errors become significant in subcarriers or symbols apart from the pilot signal. On the other hand, when channel estimation errors are little, resulting beam gain is higher. Then, when the fluctuation of frequency response or time response is greater than a threshold set in advance, a randomization pattern is in which main beams are arranged around the pilot signal, is provided. On the contrary, when the fluctuation of frequency response or time response is smaller than a threshold set in advance, a randomization pattern in which main beams are arranged irrespective of the arrangement of the pilot signal, is provided.

Further, although a case has been described with the present embodiment where one target beam is selected, the present invention is not limited to this and two or more beams may be selected as target beams. In this case, two or more beams of higher beam gain are selected from a plurality of transmission beams as target beams.

### Embodiment 2

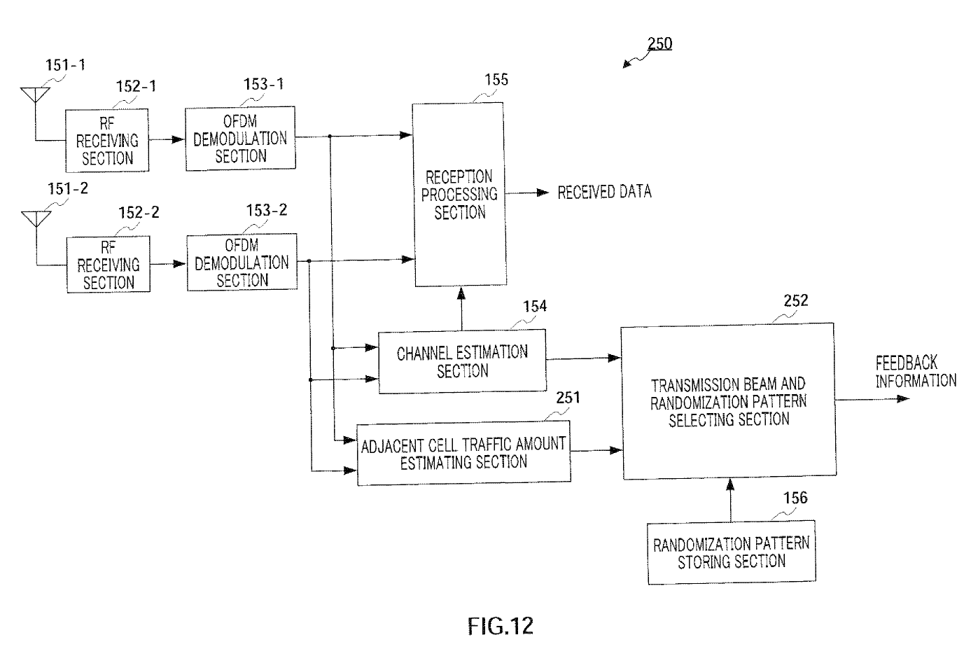

FIG. 12 is a block diagram showing a configuration of receiving apparatus 250 according to Embodiment 2 of the present invention. FIG. 12 differs from FIG. 7 in adding adjacent cell traffic amount estimating section 251 and changing transmission beam and randomization pattern selecting section 157 to transmission beam and randomization pattern selecting section 252.

Adjacent cell traffic amount estimating section 251 detects the amount of interference from an adjacent cell based on signals outputted from OFDM demodulation sections 153-1 and 153-2 and estimates the amount of traffic in the adjacent cell based on the detected amount of interference from the adjacent cell. For example, when the amount of interference from the adjacent cell is great, it is estimated that data is transmitted in the adjacent cell at all times and the amount of traffic is great. On the other hand, when the amount of interference from the adjacent cell is small, it is estimated that data is transmitted intermittently in the adjacent cell and the amount of traffic is small. Further, the amount of interference from the adjacent cell is detected by, in adjacent cell traffic amount estimating section 251, estimating the distance from the adjacent cell using the received power intensity of a signal of a relevant cell and offsetting attenuation of the distance to the amount of interference from the adjacent cell. The estimated amount of traffic in the adjacent cell is outputted to transmission beam and randomization pattern selecting section 252.

Transmission beam and randomization pattern selecting section 252 selects a randomization pattern according to the amount of traffic in the adjacent cell outputted from adjacent cell traffic amount estimating section 251, from randomization pattern storing section 156. Further, transmission beam and randomization pattern selecting section 252 selects the transmission beam that maximizes the CQI in the selected randomization pattern using the channel estimation value outputted from channel estimation section 154.

Further, the transmitting apparatus according to Embodiment 2 of the present invention employs the same configuration as the configuration shown in FIG. 6 of Embodiment 1 and will be explained adopting transmitting apparatus 100 of FIG. 6. However, randomization pattern storing section 102 of transmitting apparatus 100 stores the same randomization patterns as in randomization pattern storing section 156 of receiving apparatus 250.

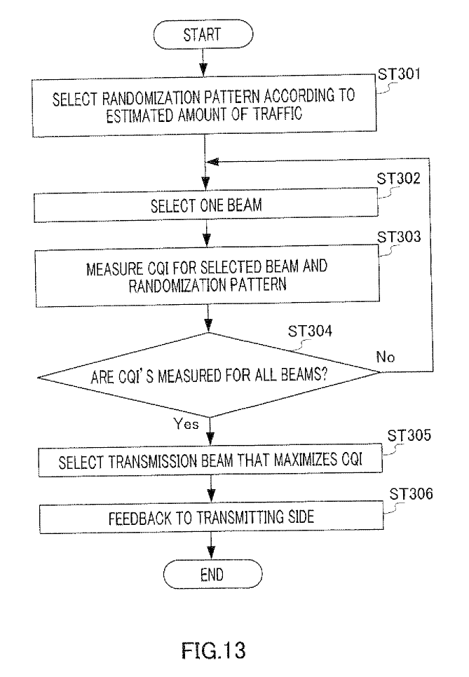

Next, selection processing in transmission beam and randomization pattern selection section 252 of receiving apparatus 250 shown in FIG. 12 will be explained using FIG. 13. In ST301, the randomization pattern according to the amount of traffic in the adjacent cell estimated by adjacent cell traffic amount estimating section 251 is selected from randomization pattern storing section 156.

In ST302, one transmission beam is selected from a plurality of transmission beams and, in ST303, the transmission beam selected in ST302 is used as the target beam and the CQI is measured in case where the randomization pattern selected in ST301 is used. The measured CQI is stored in association with the selected transmission beam and randomization pattern.

In ST304, whether or not CQI's have been measured for all of a plurality of transmission beams is detected, and, when it is decided that all beams have been measured (Yes), the flow proceeds to ST305 and, when it is decided that all beams have not been measured (No), the flow returns to ST302.

In ST305, the transmission beam that maximizes the CQI in the CQI's measured in ST303, and, in ST306, the randomization pattern selected in ST301 and the transmission beam selected in ST305 are transmitted as feedback information to transmitting apparatus 100.

Next, the randomization pattern selected by transmission beam and randomization pattern selecting section 252 will be explained. Here, an explanation will be made using the relationship shown in FIG. 3, that is, the relationship between UE 1 connected with BS 1 and UE 3 which is an adjacent cell terminal. Further, BS 1 corresponds to transmitting apparatus 100 and UE 1 corresponds to receiving apparatus 250.

Transmission beam and randomization pattern selecting section 252 selects the randomization pattern according to the amount of interference from an adjacent cell. For example, when the amount of traffic in the adjacent cell is small, the number of adjacent cell users influenced by transmission beam formation is small in the relevant cell. In such a case, randomization of a transmission beam is not so necessary, and, consequently, it is considered that beam gain is increased for the relevant cell by decreasing the randomizing effect.

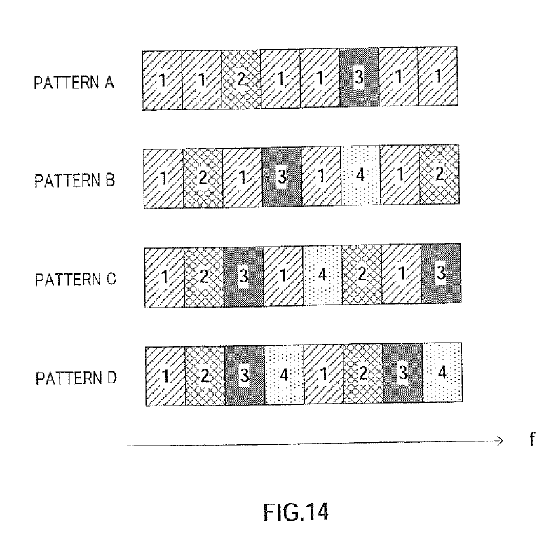

Accordingly, to realize such a selecting method, for example, randomization patterns as shown in FIG. 14 are prepared in randomization pattern storing sections 102 and 156 as randomization patterns. With this example, the number of randomization patterns is four from pattern A to pattern D. Each pattern is randomized using four beams (in FIG. 14, 1 to 4 refer to beams 1 to 4).

Here, beam 1 is the target beam, and beam 2 to beam 4 are beams to be randomized. The ratio the target beam is arranged varies between patterns.

In pattern A, the ratio of the target beam is increased by arranging the target beam in six of eight subcarriers. In pattern B, pattern C and pattern D, the target beam is arranged in four subcarriers, three subcarriers and two subcarriers, respectively, in eight subcarriers, and the ratios of the target beam decrease gradually. According to these patterns, it is possible to select a pattern of varying beam gain.

In this way, according to Embodiment 2, by selecting a randomization pattern in which the ratio the target beam is arranged is smaller when the amount of traffic in an adjacent cell is greater and selecting a randomization pattern in which the ratio the target beam is arranged is higher when the amount of traffic in the adjacent cell is smaller, it is possible to further improve beam gain for a UE in a relevant cell when the amount of traffic in the adjacent cell is small.

Further, as a randomizing method of performing switching according to the amount of traffic in the adjacent cell, by, in spatial multiplexing transmission using a plurality of beams (e.g. two beams), for example, randomizing one beam and not randomizing the other beam when the amount of traffic in the adjacent cell is small when the amount of traffic in the adjacent cell is little, it is possible to improve beam gain for the beam that is not randomized.

### Embodiment 3

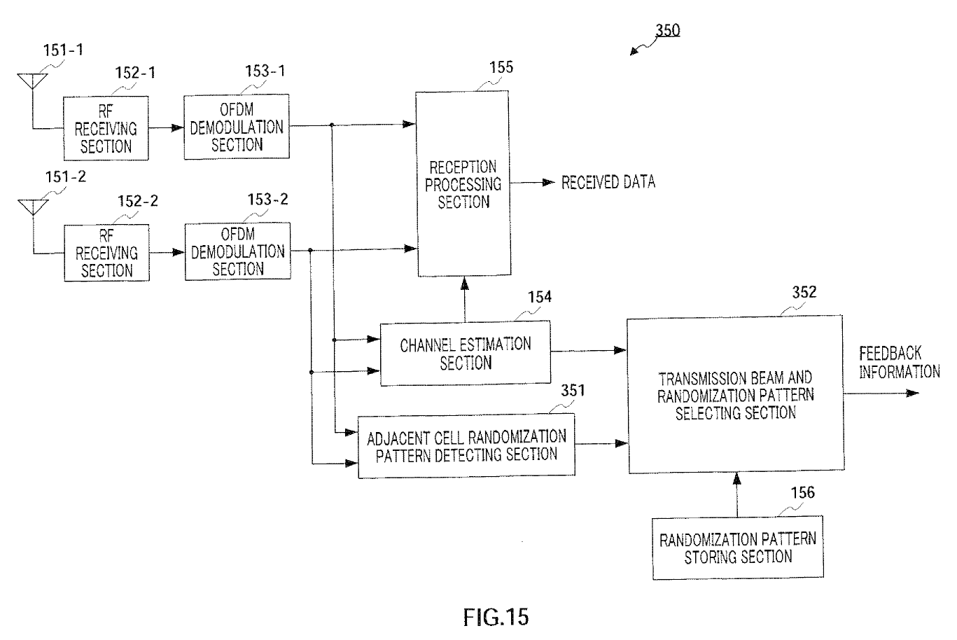

FIG. 15 is a block diagram showing a configuration of receiving apparatus 350 according to Embodiment 3 of the present invention. FIG. 15 differs from FIG. 7 in adding adjacent cell randomization pattern detecting section 351 and changing transmission beam and randomization pattern selecting section 157 to transmission beam and randomization pattern selecting section 352.

Adjacent cell randomization pattern detecting section 351 detects a randomization pattern used in an adjacent cell based on the signals outputted from OFDM demodulation sections 153-1 and 153-2. Further, assume that each BS broadcasts the randomization pattern in use by broadcast information, and adjacent cell randomization pattern detecting section 351 extracts broadcast information of the adjacent cell from a received signal and detects the randomization pattern used in the adjacent cell. The detected randomization pattern of the adjacent cell is outputted to transmission beam and randomization pattern selecting section 352.

Transmission beam and randomization pattern selecting section 352 selects a randomization pattern other than the randomization pattern used in the adjacent cell and outputted from adjacent cell randomization pattern detecting section 351, from randomization pattern storing section 156. Then, transmission beam and randomization pattern selecting section 352 selects the transmission beam that maximizes the CQI in the selected randomization pattern using the channel estimation value outputted from channel estimation section 154.

Further, the transmitting apparatus according to Embodiment 3 of the present invention employs the same configuration as the configuration shown in FIG. 6 of Embodiment 1 and will be explained adopting transmitting apparatus 100 of FIG. 6. However, randomization pattern storing section 102 of transmitting apparatus 100 stores the same randomization patterns as in randomization pattern storing section 156 of receiving apparatus 350.

In this way, by selecting a pattern other than the randomization pattern used in the adjacent cell, near, for example, a cell edge in which received power is little in a relevant cell and which is close to the adjacent cell of great interference, a user is able to acquire the randomizing effect in the adjacent cell in a reliable manner and improve beam gain. By the way, the user near the cell edge is close to the adjacent cell and, consequently, is able to receive broadcast information of the adjacent cell at ease.

In this way, according to Embodiment 3, by selecting a pattern other than the randomization pattern used in the adjacent cell, it is possible to randomize interference from the adjacent cell in a reliable manner and improve beam gain. Further, it is also possible to randomize the amount of interference given to the adjacent cell in a reliable manner, so that it is possible to suppress the fluctuation of interference given to the adjacent cell.

Further, as the method of selecting a randomization pattern, by setting patterns of a high randomizing effect in advance, the pattern may be selected preferentially from this set. For example, by making a set of a pattern for arranging the target beam in even-numbered subcarriers and a pattern for arranging the target beam in odd-numbered subcarriers and selecting a pattern that varies between adjacent cells, the randomizing effect can be acquired from the target beam, so that it is possible to improve beam gain.

### Embodiment 4

In standardization of LTE, to improve the frequency scheduling effect in MIMO transmission, CDD-based precoding for controlling the delay amount by closed loop is being studied. CUD refers to a method of generating frequency selectivity in a received signal by transmitting an OFDM signal from one antenna and transmitting an OFDM signal subjected to cyclic delay from another antenna.

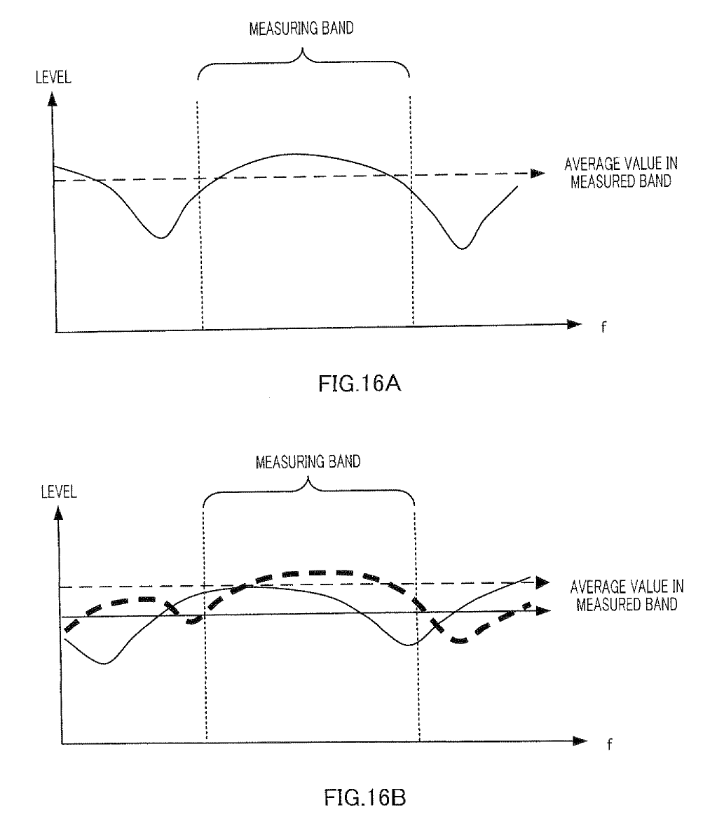

3GPP R1-063345 discloses a method of improving a frequency scheduling effect for a target user by using CDD of short delay and generating frequency selectivity changing moderately with respect to the measured band. FIG. 16A shows the receiving state in a target user at this time.

However, CDD is used and, therefore, an adjacent cell user receives interference of a transmission beam of frequency selectivity. When a communicating user switches and the transmission beam switches or when a transmission beam or frequency selectivity in the target user switches, the amount of interference given to the adjacent cell user fluctuates. FIG. 16B shows the receiving state in the adjacent cell user at this time.

A case will be explained with Embodiment 4 of the present invention where CDD-based precoding in which precoding is combined with CDD (Cyclic Delay Diversity) is used.

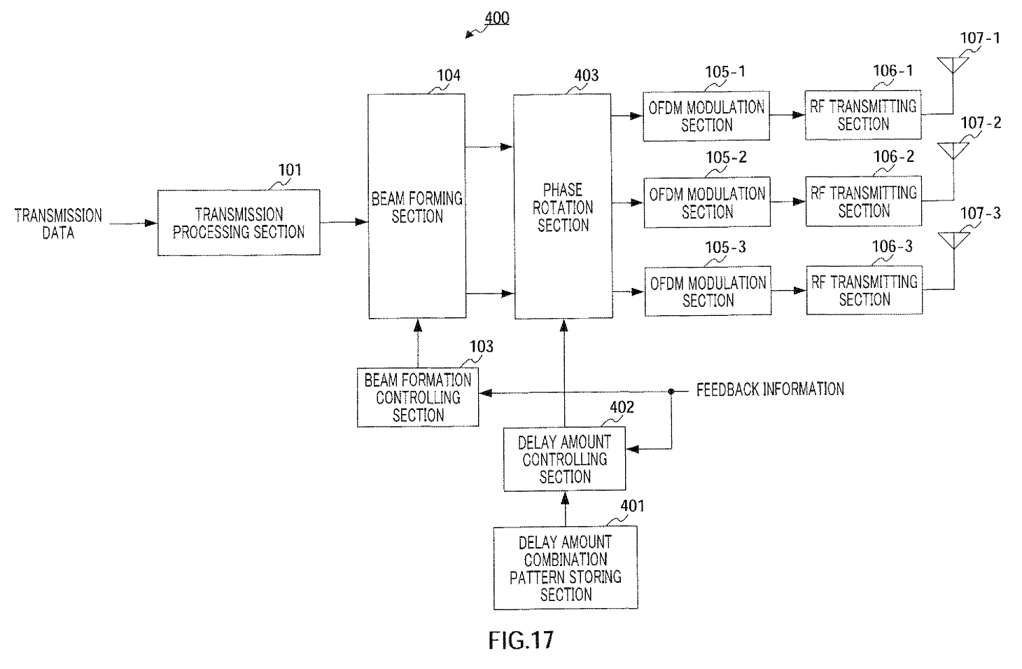

FIG. 17 is a block diagram showing a configuration of transmitting apparatus 400 according to Embodiment 4 of the present invention. FIG. 17 differs from FIG. 6 in adding delay amount combination pattern storing section 401, delay amount controlling section 402 and phase rotation section 403 and increasing the number of antennas to three.

Delay amount combination pattern storing section 401 stores per antenna a pattern associated with the delay amount of a signal transmitted (i.e. delay amount combination pattern), and outputs the stored delay amount combination pattern to delay amount controlling section 402. Specific examples of the delay amount combination pattern will be shown in following table 1. In table 1, antennas 1 to 3 correspond to antennas 107-1 and 107-3 in FIG. 17. Further, zero means zero delay, S means short delay and L means long delay.

TABLE 1

| | | | Pattern | Pattern | Pattern | Pattern |
|---|---|---|---|---|---|---|
| | Pattern A | Pattern B | C | D | E | F |
| Antenna 1 | 0 | 0 | S | S | L | L |
| Antenna 2 | S | L | 0 | L | 0 | S |
| Antenna 3 | L | S | L | 0 | S | 0 |

In table 1, for example, pattern C refers to transmitting a signal of short delay from antenna 1, a signal of zero delay from antenna 2 and a signal of long delay from antenna 3. Further, short delay and long delay use fixed values. As the fixed values, for example, short delay is fixed to the delay amount such that frequency selectivity is 0.5 cycle, that is, to the delay amount such that one peak is generated, in the transmission band of the user, and, on the other hand, long delay is fixed to the delay amount such that a plurality of peaks are generated in the transmission band of the user.

Delay amount controlling section 402 reads a combination pattern of delay amounts from delay amount combination pattern storing section 401 based on delay amount combination pattern information included in feedback information transmitted from receiving apparatus 450 (described later). Delay amount controlling section 402 determines the delay amount of each transmitting antenna according to the read combination pattern of delay amounts and outputs the determined delay amount to phase rotation section 403.

Phase rotation section 403 rotates the phase of each subcarrier of a transmission signal outputted from beam forming section 104 according to the delay amount of each transmitting antenna outputted from delay amount controlling section 402, and outputs the transmission signal to OFDM modulation sections 105-1 to 105-3. Further, without providing phase rotation section 403, cyclic delay may be added to an OFDM modulated signal according to the delay amount of each transmitting antenna.

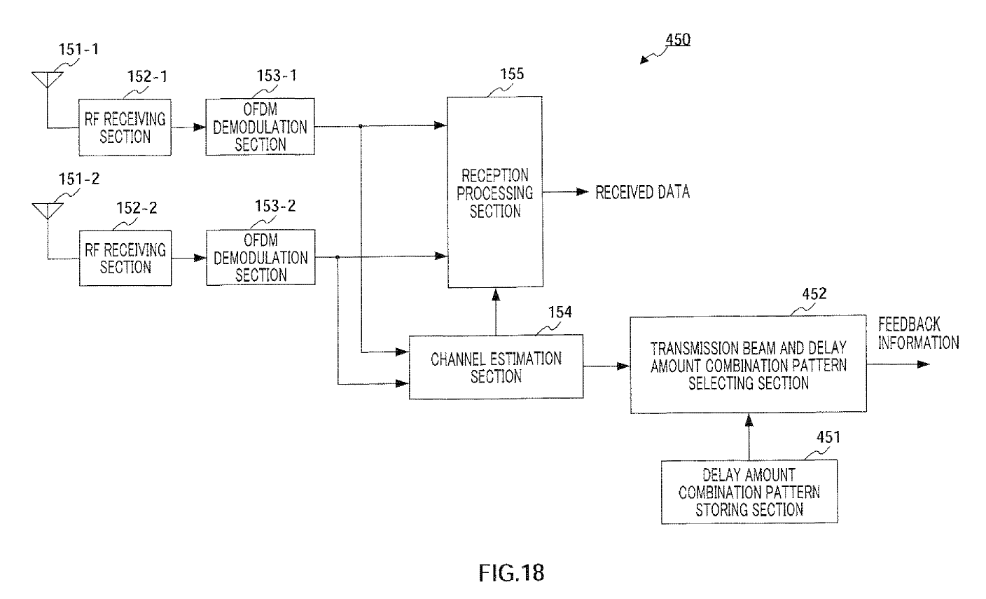

FIG. 18 is a block diagram showing a configuration of receiving apparatus 450 according to Embodiment 4 of the present invention. FIG. 18 differs from FIG. 7 in changing randomization pattern storing section 156 to delay amount combination pattern storing section 451 and changing transmission beam and randomization pattern selecting section 157 to transmission beam and delay amount combination pattern selecting section 452.

Delay amount combination pattern storing section 451 stores the same patterns as the delay amount combination patterns included in delay amount combination pattern storing section 401 of transmitting apparatus 400 shown in FIG. 17, and outputs the stored delay amount combination patterns to transmission beam and delay amount combination pattern selecting section 452.

Transmission beam and delay amount combination pattern selecting section 452 measures the CQI per pattern stored in delay amount combination pattern storing section 451 using the channel estimation value outputted from channel estimation section 154, and selects the delay amount combination pattern in which the measured CQI is maximum and the target transmission beam in this pattern. The selected delay amount combination pattern and the target transmission beam are outputted as feedback information to delay amount controlling section 402 and beam formation controlling section 103 of transmitting apparatus 400 shown in FIG. 17. Further, the details of the selection processing in transmission beam and delay amount combination pattern selecting section 452 are the same as steps of the flowchart shown in FIG. 8 of Embodiment 1 in which the randomization pattern is changed to the delay amount combination pattern, and description thereof will be omitted here.

Furthermore, although the number of receiving antennas is two, three or more antennas may be used as in transmitting apparatus 400. In this case, other parts of receiving apparatus 450 may be the same except that the number of receiving antennas is increased. When signals are multiplexed using three beams in transmitting apparatus 400, three or more receiving antennas are required.

Next, a CDD transmitting method using short delay and long delay at the same time will be explained. By transmitting a signal of zero delay, a signal of short delay and a signal of long delay from the respective three transmitting antennas, it is possible to realize CDD transmission using short delay and long delay at the same time. The characteristics of CDD will be briefly explained below.

Short delay CDD is able to generate moderate frequency selectivity. That is, by generating moderate frequency selectivity that does not make a cycle in an assigned band of a user, the user can acquire the frequency scheduling effect. On the other hand, long delay CDD is able to generate strong (i.e. minute) frequency selectivity. That is, by generating strong frequency selectivity with a plurality of peaks in an assigned band of a user, the user is able to acquire the frequency diversity effect.

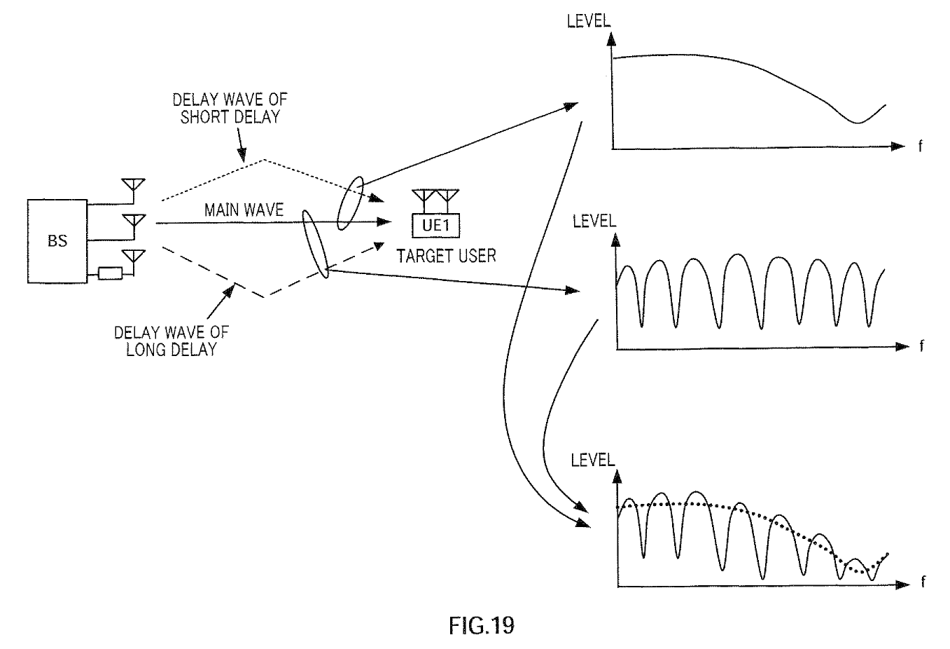

Strong frequency selectivity according to long delay CDD is generated in given interference upon an adjacent cell user. This strong frequency selectivity provides the randomizing effect of given interference for the adjacent cell user. As shown in FIG. 19, by using short delay CDD and long delay CDD at the same time, it is possible to randomize given interference from an adjacent cell while the target user acquires the frequency scheduling effect. To realize this, short delay CDD and long delay CDD need to be placed at different antennas, and, therefore, three or more antennas are required.

Next, patterns shown in table 1 will be explained as examples as combination patterns of each transmitting antenna and the delay amount of a signal transmitted from each transmitting antenna.

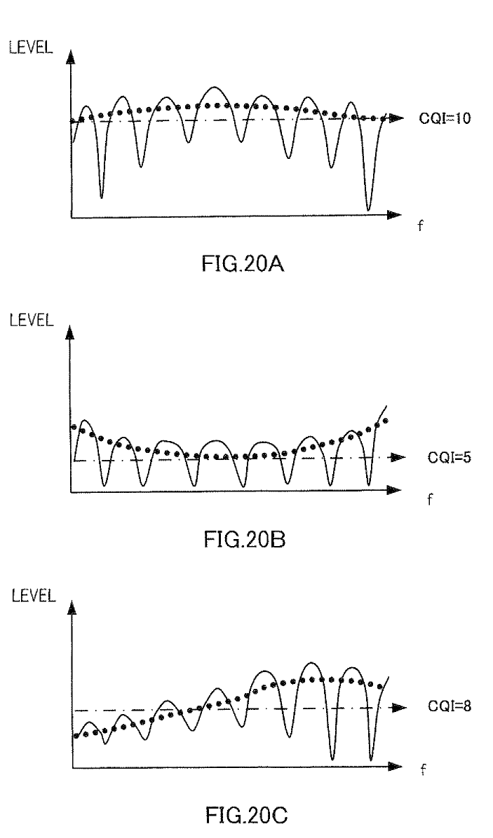

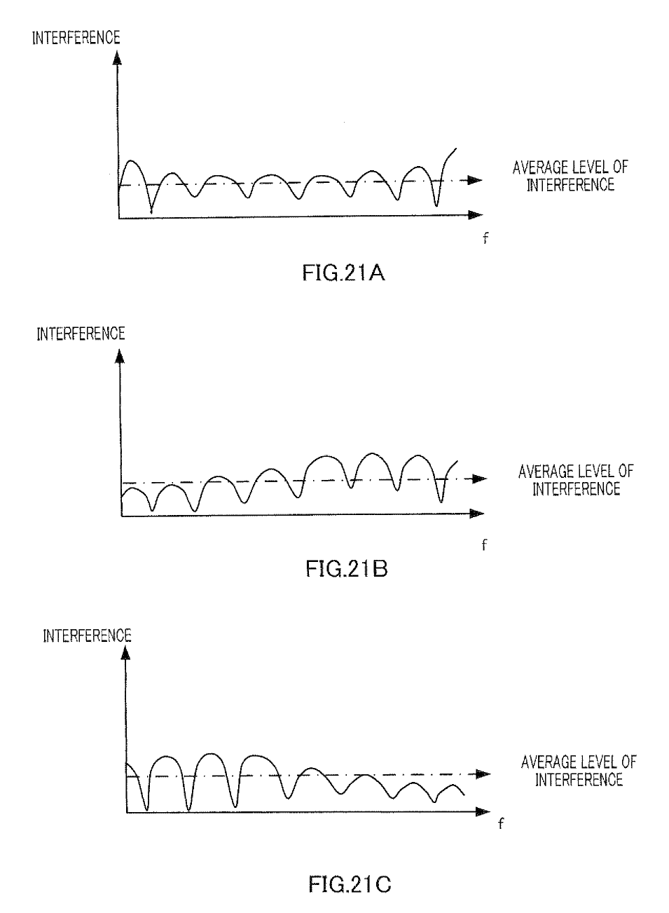

FIG. 20 shows the state where the CQI is measured in the target user using each pattern shown in table 1. Further, FIG. 21 shows the receiving state in an adjacent cell user in case where transmission is performed using each pattern. However, although FIG. 20's A to C and FIG. 21's A to C show patterns A to C, patterns D to F can be construed likewise.

FIG. 20 shows a result of measuring the CQI using each pattern and the CQI is maximum in case of pattern A shown in FIG. 20A. Then, in FIG. 20, pattern A is selected as the delay amount combination pattern. Here, as in the transmission beam, the CQI is measured for each transmission beam and the transmission beam that maximizes the CQI is selected.

At this point, the adjacent cell user is in the receiving state shown in FIG. 21. Even when any delay amount combination pattern is transmitted from the base station, thanks to the randomizing effect by long delay CDD, the average level of interference is suppressed small and the fluctuation of the average levels of interference is suppressed small between patterns.

In this way, according to Embodiment 4, when the transmitting apparatus having three or more transmitting antennas carry out short delay CDD and long delay CDD at the same time, the receiving apparatus selects the pattern and transmission beam that maximizes the CQI in combination patterns of transmitting antennas and delay amounts, so that it is possible to suppress the average amount of interference given to an adjacent cell thanks to the randomizing effect of the frequency selectivity of CDD while securing the quality in the target user and suppress the fluctuation of the amount of interference given to the adjacent cell even when the transmission beam and frequency selectivity switch.

Further, there are combination patterns shown in table 2 and table 3 for example, as delay amount combination patterns in case where there are four transmitting antennas. Patterns shown in table 2 are combinations for transmitting long delay CDD from two antennas. With these combinations, the adjacent cell user receives two signals of long delay providing the randomizing effect, so that it is possible to acquire the diversity effect. By this means, the randomizing effect of given interference increases.

On the other hand, patterns shown in table 3 are combinations for transmitting short delay CDD from two antennas. With these combinations, for the target user, frequency selectivity becomes stronger and the fluctuation of the CQI (i.e. received SINR) in the measured band increases. By this means, the frequency scheduling effect increases.

Further, combination patterns in table 2 and table 3 may be put together as one group. In this case, the number of combinations doubles compared to table 2 or table 3, so that the possibility of selecting combination candidates suitable to the receiving state increases.

TABLE 2

| | Pattern | | | | | | | | | | | |
|---|---|---|---|---|---|---|---|---|---|---|---|---|
| | A | B | C | D | E | F | G | H | I | J | K | L |
| Antenna 1 | 0 | 0 | 0 | S | L | L | S | L | L | S | L | L |
| Antenna 2 | S | L | L | 0 | 0 | 0 | L | S | L | L | S | L |
| Antenna 3 | L | S | L | L | S | L | 0 | 0 | 0 | L | L | S |
| Antenna 4 | L | L | S | L | L | S | L | L | S | 0 | 0 | 0 |

TABLE 3

| | Pattern | | | | | | | | | | | |
|---|---|---|---|---|---|---|---|---|---|---|---|---|
| | A | B | C | D | E | F | G | H | I | J | K | L |
| Antenna 1 | 0 | 0 | 0 | S | S | L | S | D | L | S | S | L |
| Antenna 2 | S | S | L | 0 | 0 | 0 | S | L | S | S | L | S |
| Antenna 3 | S | L | S | S | L | S | 0 | 0 | 0 | L | S | S |
| Antenna 4 | L | S | S | L | S | S | L | S | S | 0 | 0 | 0 |

Further, upon transmission using four antennas, the configurations are the same between transmitting apparatus 400 shown in FIG. 17 and receiving apparatus 450 shown in FIG. 18 except that the numbers of transmitting and receiving antennas become four. Further, the processing flows are the same.

Also, although cases have been described with the above embodiment as examples where the present invention is configured by hardware, the present invention can also be realized by software.

Bach function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2006-288950, filed on Oct. 24, 2006, and Japanese Patent Application No. 2007-120847, filed on May 1, 2007, including the specifications, drawings and abstracts, are incorporated herein by reference in their entirety.

### INDUSTRIAL APPLICABILITY

The wireless communication apparatus and wireless communication method according to the present invention is able to suppress the fluctuation of interference given to an adjacent cell while maintaining beam gain for a UE in a relevant cell even when transmission beams switch, and is applicable to, for example, a base station apparatus and communication terminal apparatus in a mobile communication system.

1. A wireless communication apparatus comprising:
a controlling section that acquires feedback information transmitted from a communicating party and that selects a randomization pattern in which an arrangement of a plurality of transmission beams is randomized, according to a channel condition shown by the acquired feedback information; and
a beam forming section that forms transmission beams based on the selected randomization pattern.

2. The wireless communication apparatus according to claim 1, wherein the controlling section selects a randomized randomization pattern according to frequency response.

3. The wireless communication apparatus according to claim 1, wherein the controlling section switches a randomization pattern randomized in the frequency domain and a randomization pattern randomized in the time domain according to time fluctuation in the channel condition.

4. The wireless communication apparatus according to claim 1, wherein, when fluctuation of frequency response or time response is greater than a predetermined threshold, the controlling section selects a randomization pattern in which a target beam is arranged close to a pilot signal.

5. The wireless communication apparatus according to claim 1, wherein controlling section selects a randomization pattern in which two or more transmission beams are target beams of the communicating party.

6. The wireless communication apparatus according to claim 1, wherein the controlling section acquires an amount of traffic in an adjacent cell and selects a randomization pattern according to the acquired amount of traffic in the adjacent cell.

7. The wireless communication apparatus according to claim 6, wherein the controlling section selects a randomization pattern in the communicating party in which a ratio the target beam is arranged varies, according to the amount of traffic in the adjacent cell

8. The wireless communication apparatus according to claim 6, wherein, when spatial multiplexing is performed using a plurality of transmission beams, the controlling section selects a randomization pattern applied to one of the plurality of transmission beams, according to the amount of traffic in the adjacent cell.

9. The wireless communication apparatus according to claim 1, wherein the controlling section acquires a randomization pattern used in an adjacent cell and selects a randomization pattern other than the acquired randomization pattern.

10. A wireless communication method comprising:
acquiring feedback information transmitted from a communicating party and selecting a randomization pattern in which an arrangement of a plurality of transmission beams is randomized, according to a channel condition shown by the acquired feedback information; and
forming transmission beams based on the selected randomization pattern.
